(19) United States
(12) Patent Application Publication
(10) Pub. No.: US 2003/0196199 A1
(43) Pub. Date: Oct. 16, 2003

(54) Method of identifying user for watching DTV over the Internet

(75) Inventors: Fu-Sheng Chiu, Taipei (TW); Chi-Yu Lai, Taipei (TW)

Correspondence Address: BACON & THOMAS, PLLC, 625 SLATERS LANE, FOURTH FLOOR, ALEXANDRIA, VA, 22314

(73) Assignee: ERA Digital Media Co., Ltd., Taipei (TW)

(21) Appl. No.: 10/162,556

(22) Filed: Jun. 6, 2002

(30) Foreign Application Priority Data
Apr. 11, 2002 (TW) 091107373

(51) Int. Cl. H04N 7/173; H04N 7/16; H04N 7/20

(52) U.S. Cl. 725/25; 725/68; 725/110

(57) ABSTRACT

The present invention relates to a method of identifying a user for watching a digital television (DTV) program, which enables a user of a client to enter an interactive AV program provider's server through Internet, and input an identification (ID) in a Web page of the provider displayed on the client. After identifying the input ID is an authorized ID, the server may grant an access right of at least one satellite program channel to the client and immediately search a channel selected by the user, and then send a satellite program being received from a satellite and broadcast on the selected channel to the user immediately. Thus, the user can watch satellite program over the Internet on the computer at home in an almost real time manner.

### FIELD OF THE INVENTION

The present invention relates to a method of identifying a user for watching a digital television (DTV) program, such as a movie or a concert, on a computer monitor at home over the Internet.

### BACKGROUND OF THE INVENTION

Current televisions (TVs) are almost analog system based TVs which have been developed for more than 50 years. Such TVs can only receive analog signals, and can also receive DTV signals if a DTV set-top box is coupled. However, due to the inherent video limitation of an analog TV, a high definition picture available by DTV cannot totally be displayed on the analog TV. As regards, what is the so-called DTV, it is generally defined as a TV capable of receiving any one of 18 types of DTV broadcast signals. Therefore, the Consumer Electronics Association (CEA) classifies DTVs into three categories, i.e. High Definition TVs (HDTVs), Enhanced Definition TVs (EDTVs), and Standard Definition TVs (SDTVs).

Though DTV or Digital Video Broadcast (DVB) has been available throughout the world in the recent years, there are still a variety of the formats relating to DTV and DVB being utilized in the related industry such as DTV broadcast providers or digital video equipment manufacturers. For example, in the field of broadcast TV, there are different formats of standards, such as DVB-T DVB-C, and DVB-S (European standard) and ATSC (American standard). As to the field of DVB, there are Eureka-147 (European standard) and IBOC (American standard). In other words, there is no unique standard. Even if there is a unique standard, there are still some problems existing therein. As already understood, the analog TVs still dominate the TV market. It can be a big blow to the users if all analog TVs can no longer be used suddenly under the reasons that all the programs being broadcast are changed into digital formats. Also, it will also become a huge financial burden to the TV manufacturers for changing all their manufacturing lines and facilities into the ones available for manufacturing DTV. That is why DTVs are still not popular among users under the above the reasons.

Information technology has been in a rapid and a spectacular development leading to an increasing use of computers and mobile communication equipment. It not only shortens physical and time distances between people, but also makes our daily life better. Moreover, the Internet related services are booming, especially in e-business, due to ever increasing expansion thereof. It is envisaged that many people will view the quality, convenience, and effectiveness of e-business provided by one country as an index for determining whether such country is among one of the countries leading in the information technology. In this 21st century, the Internet has become more involved in our daily life, and can be viewed as a central nerve system of the society. The Internet may connect various fields of a country such as politics, economics, culture, and national defense together. By utilizing the Internet, people can talk and/or exchange messages in a very quick and convenient way. For example, one user may send his/her message to a remote user by means of video/audio (AV) feature of a computer over the Internet in a very short period of time. It can be asserted that this century is an Internet age. The features available by the Internet, in addition to basic voice communication, further include powerful capabilities of handling, storing and processing the multimedia data. For peoples living in this era dominated by the intellectual economy, it is definitely sure that who can integrate the information and broadcast together over the Internet will not only apparently affect their lives, but also obtain incredible advantages therefrom.

Over the past several years, there has been a simultaneous growth in the Internet and expansion of the World Wide Web (“WWW”), which provide a variety of multimedia services including any combination of text, pictures, sound, and video. Many people take Internet access as a part of their daily lives. For keeping up with such trend, a variety of high speed network devices are developed. For example, there are cable modems and Asymmetric Digital Subscriber Line (ADSL) modems. Moreover, a number of network related peripherals are added into the Internet environment for enhancing its capabilities, such as a Voice over Internet Protocol Device (VoIP) being utilized in the Internet for providing online communication services to the users, thereby significantly reducing expenditure in long distance and international calls. Another one is a Video on Demand (VoD) being utilized in the Internet for enabling a user to select a desired movie from video server at any time and watch the same almost simultaneously. The VoD is particularly applicable to culture related media because it includes sound and video. One exemplary example is National Information Infrastructure (NII) sponsored by Taiwan Government, who aims at developing VoD technology for the goal enabling users to effectively and efficiently retrieve information from the Internet and achieving a true interaction between computer and people. Hence, it is envisaged that the VoD will be widely used in the public in the near future.

In conclusion, though there are still some obstacles yet removed in developing DTV, the ever increasing expansion in information and Internet technologies enable the Internet being widely used in almost every field. If the Internet technology can be cooperating and combined with the satellite technology, it will make all the features of DTV being fulfilled through the satellite and Internet into our daily lives. Therefore, in order to bring the substantially same effect of DTV to the users, the combination of the current Internet and satellite technology should be the main target needed to be carried out by the DTV relating entrepreneurs. It will thus bring lots of benefits for both entrepreneurs and users while the above target being achieved.

### SUMMARY OF THE INVENTION

It is therefore an object of the present invention to provide a method of identifying a user for watching a DTV program on a computer over the Internet wherein at least one client's computer is connected to an interactive AV program provider's server over the Internet. The method comprising the steps of permitting a client's computer to gain access to the Internet and enter the program provider's server; displaying a Web page of the interactive AV program provider at the server on the computer at the client; prompting a membership field on the Web page for a user inputting an ID thereof on the computer; reading the ID of the user by the computer prior to sending the same to the server for identification; determining whether the ID is correct by the server; if the determination is positive, granting an access right of at least one satellite program channel to the computer for being selected by the user; reading the channel selected by the user; creating a request associated with the channel and sending the same to the server over the Internet. In response to the request, the server is operable to immediately search a database thereof for finding a corresponding channel as indicated in the request, and send a multimedia stream of a satellite program being broadcast on the channel to the user immediately while the channel being found. By utilizing this method, a user can watch satellite program over the Internet at home in real time.

The above and other objects, features and advantages of the present invention will become apparent from the following detailed description taken with the accompanying drawings.

### BRIEF DESCRIPTION OF THE DRAWINGS

FIG. 1 presents schematically a network structure applicable for a preferred embodiment according to the invention;

FIG. 2 is a flow chart illustrating a process according to the invention; and

FIGS. 3 and 4 are perspective views illustrating two exemplary displays shown on a computer monitor according to the invention.

### DETAILED DESCRIPTION OF THE PREFERRED EMBODIMENTS

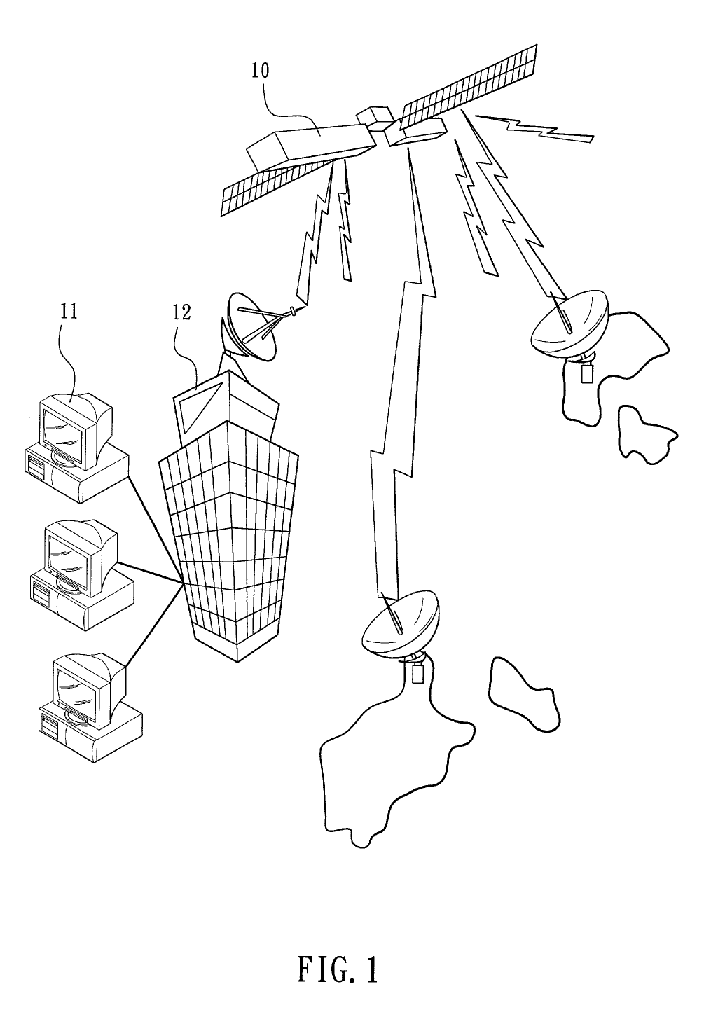

The invention is directed to a method of identifying a user for watching DTV over the Internet. Referring to FIG. 1, the method enables a user to access the Internet for selecting and watching satellite programs (e.g., TV program) broadcast via a satellite 10 at any time, wherein the user may use a client's computer 11 (hereinafter also referred as client) to access the Internet. Once the client 11 is connected with an interactive AV program provider's server 12 (hereinafter also referred as server) through the Internet, a Web page of the provider is displayed on a monitor of the computer. A membership field is prompted on the Web page so that the user can input an identification (ID) on the monitor. Then, the interactive AV program provider's server 12 may identify whether the input ID is an authorized ID. Once the input ID being identified as an authorized ID, the server 12 may grant an access right of at least one satellite program channel to the client 11 for selection. After the user has selected one channel, a request associated with the channel is sent to the server 12. In response to the request, the server 12 may immediately search a corresponding channel as indicated in the request, and send a satellite program received from the satellite 10 and broadcast on the channel to the user immediately after the corresponding channel being found. Thus, the user can watch satellite program over the Internet on the computer at anywhere in real time.

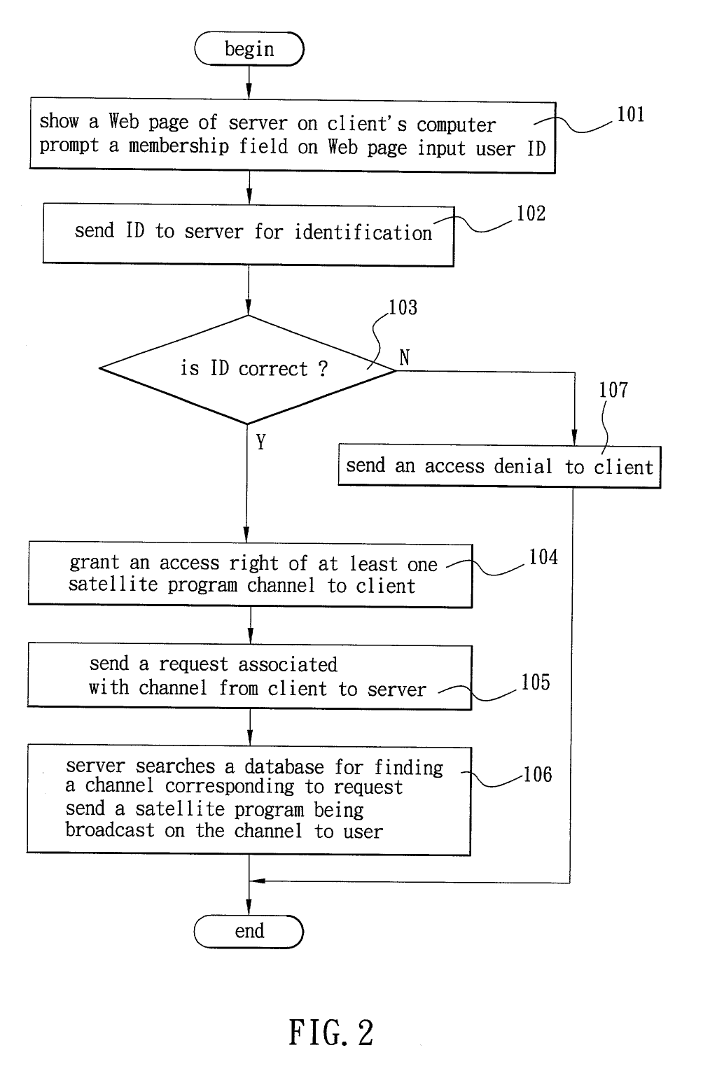

As stated above, the method of the invention enables at least one client 11 to watch the interactive AV program received from the satellite 10 and broadcast by the server 12 over the Internet. The method comprises the following steps, as best illustrated in a flow chart of FIG. 2:

In step 101, once the client 11 gaining an access to the Internet and entering the server 12, displaying a Web page of the interactive AV program provider on a monitor of the client 11, wherein a membership field is prompted on the Web page so that a user at the client 11 can input an ID on the monitor.

In step 102, reading the input ID of user by the client 11, and sending the input ID to the server 12 for identification.

In step 103, identifying the input ID by the server 12 to determine whether the input ID is a duly authorized ID. If yes, the process goes to step 104. Otherwise, the step jumps to step 107.

In step 104, granting an access right of at least one satellite program channel by the server 12 and sending the information thereof to the client 11 for selecting a channel.

In step 105, sending a request to the server 12 over the Internet by the client 11 after a channel being selected by the user.

In step 106, in response to the request, immediately searching a database by the server 12 for finding a corresponding channel as indicated in the request, and sending a multimedia stream of a satellite program being received from the satellite and broadcast on the channel to the client 11 immediately after the selected channel being found.

In step 107, sending an access denial to the client by the server 12 if there isn't a duly authorized ID identical to the input ID is found in the database.

In the present the invention, the ID may comprise a user name and a password so that the interactive AV program provider's server 12 can identify the correctness of membership in a more reliable manner by double checking the user name and the password.

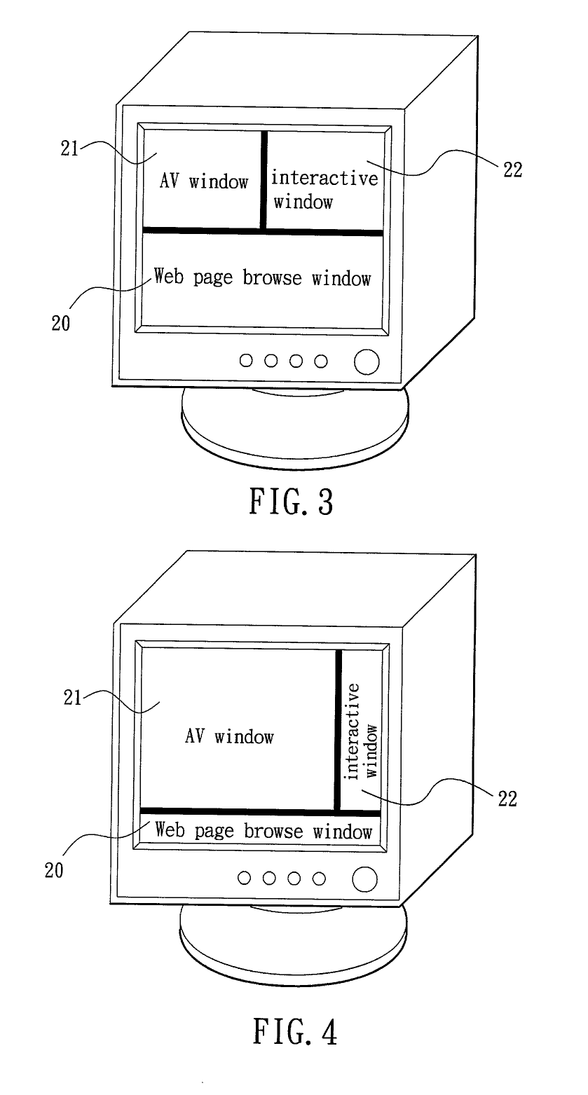

In the present the invention, while the user entering a Web page of the interactive AV program provider via the Internet and inputting his or her ID, the Web page provided by the server 12 further comprises at least one browse window simultaneously shown thereon. Such features may be best illustrated in FIG. 3 wherein the first window is a Web page browse window 20 about the Internet. The Web page browse window 20 is so-called the main display of a Web page for providing online data inquiry, hyperlink, and Web page searching. The second browse window is a AV window 21 (e.g., media player) for playing a satellite program sent from the server 12 and enabling the user to watch the satellite program on the client's computer 11 in a real time manner. The third browse window is either an interactive window 22 (e.g., chat room) for chatting with other members or an online program guide which offers TV channel listings, etc. Alternatively, the interactive window 22 is a window only dedicated to members for changing his/her user name and/or password, etc.

Alternatively, the invention is directed to a method of simultaneously displaying AV and Web page related information on the same Web page. Hence, a user can use Internet search engines to search data or chat with other members in the chat room while watching satellite program. This is contrary to a prior art, in which another AV window needs to be opened while a selected movie is playing on the Web page thereof. Referring to FIG. 4, it is seen that these windows are bordered each other. Once a certain window is selected, user can adjust the size of that window, i.e., dragging a mouse to enlarge or reduce the window size to a desired one. For example, the AV window 21 is enlarged by dragging the mouse pointed at the border of the AV window 21 outward so as to watch a satellite program more clearly.

The following description relates to an embodiment of this invention, it is assumed that Mr. Chen has become an online AV member of ERA Company in Taipei, Taiwan. Once Mr. Chen has accessed to the Internet and entered a Web page of ERA Company through his computer, a Web page about life information (such as new movie arrivals, concerts, new pop songs, and hyperlink to other life messages) is shown on the Web page for being selected by Mr. Chen on his computer. After Mr. Chen inputs his ID (e.g., user name of Tom and password of 1234) on a membership field prompted on the Web page, the input ID is sent to ERA Company for identification. Once the input ID being identified as an authorized ID, the services (e.g., chat room, movie playing, and song playing) dedicated to members are provided on the monitor of Mr. Chen's computer. For example, Mr. Chen desires to watch a movie he may choose one of the movies being broadcast on four channels as listed on the online satellite program guide. In case Mr. Chen chooses the film, namely “Jurassic Park”, being playing on Channel 1, a request about opening the Channel 1 is sent to ERA company in real time. Once ERA company has received the request, it will open Channel 1 and send the “Jurassic Park” being playing thereon (i.e., satellite program) to Mr. Chen's computer, enabling Mr. Chen to watch a satellite program playing on his computer at home in almost real time.

Summing up the above, the invention enables the user to watch a satellite program on his computer in an almost real time manner merely by cooperating the current well developed information and Internet technologies with the satellite technology without significantly changing the TV systems or the apparatus. Therefore, there is no need for the users to buy expensive DTVs and for the entrepreneurs to change all analog TV manufacturing lines into DTV ones.

While the invention has been described by means of specific embodiments, numerous modifications and variations could be made thereto by those skilled in the art without departing from the scope and spirit of the invention set forth in the claims.

What is claimed is:

1. A method of identifying a user for watching a DTV program on a computer over the Internet wherein at least one client is connected to an interactive AV program provider at a server over the Internet, the method comprising the steps of:
displaying a Web page of the interactive AV program provider on the client once the client gaining an access to the Internet and entering the server;
reading the input ID of user by the client, and sending the input ID to the server for identification;
identifying the input ID by the server to determine whether the input ID is a duly authorized ID;
if identifying the input ID is a duly authorized ID, granting an access right of at least one satellite program channel by the server and sending the information thereof to the client for selecting a channel;
sending a request to the server over the Internet by the client after a channel being selected by the user.
in response to the request, immediately searching a database by the server for finding a corresponding channel as indicated in the request, and sending a multimedia stream of a satellite program being received from a satellite and broadcast on the channel to the client immediately after the selected channel being found.

2. The method of claim 1, wherein while displaying a Web page of the interactive AV program provider on the client, a membership field is prompted on the Web page so that a user at the client can input an ID on the monitor.

3. The method of claim 1, wherein if identifying the input ID isn't a duly authorized ID, sending an access denial to the client by the server.

4. The method of claim 1, wherein the ID comprises a user name and a password.

5. The method of claim 1, wherein the Web page further comprises a plurality of browse windows simultaneously shown thereon.

6. The method of claim 5, wherein the browse window is a Web page browse window about the Internet for providing online data inquiry, hyperlink, and Web page searching.

7. The method of claim 5, wherein the browse window is an AV window for playing the satellite program sent from the server in real time.

8. The method of claim 5, wherein the browse window is an interactive window.

9. The method of claim 5, wherein the browse windows are bordered each other so that in response to a selection of one browse window, a size of the selected browse window is adjustable.
